(19) United States
(12) Patent Application Publication
(10) Pub. No.: US 2004/0241335 A1
(43) Pub. Date: Dec. 2, 2004

(54) Process for applying a camouflage pattern to a vehicle

(75) Inventors: Dale Gerard Motzko, West Liberty, OH (US); Darin Douglas King, Raymond, OH (US)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Minato-ku (JP)

(21) Appl. No.: 10/838,611

(22) Filed: May 4, 2004

Related U.S. Application Data
(60) Provisional application No. 60/468,985, filed on May 8, 2003.

(51) Int. Cl. B05D 3/00

(52) U.S. Cl. 427/430.1; 427/299; 427/402

(57) ABSTRACT

The present invention relates to a method for decorating an ATV part with a camouflage pattern, wherein the ATV body part is made from a polyolefin. The method includes first fluorinating the ATV body part to increase adhesion and then applying a design to the part using a hydrographic process. The method may also optionally include applying a base primer. A clear coat may also be applied. The ATV body part is preferably made from high-density polyethylene.

### CROSS REFERENCE TO RELATED APPLICATION

This application claims the benefit of priority to U.S. Provisional Application Ser. No. 60/468,985 filed May 8, 2003, which is herein incorporated by reference.

### BACKGROUND OF THE INVENTION

The present invention relates to a process for applying a pattern to a plastic part. More particularly, the present invention relates to a process for applying a camouflage pattern to a body part of a vehicle, such as an all terrain vehicle (ATV) made from high-density polyethylene (HDPE).

As its name implies, an ATV is a vehicle specifically designed to travel over all types of terrain, especially rough terrain that is impassible to most other types of vehicles. ATV's are typically small, powerful and very maneuverable. ATV's are commonly used in agricultural, livestock handling, hunting and recreational applications. Since ATV's move over inhospitable terrain and are subjected to inclement conditions, ATV's have a rugged construction. This rugged construction includes the bodies of ATV's. In order to withstand impacts with rocks and other debris, the bodies of ATV's are typically constructed of a material that is strong, resilient and not easily dinged, dented, cracked or otherwise blemished. Materials that are commonly used to form ATV bodies are polyolefins, such as polypropylene and polyethylene.

There are many different processes that have been used to put patterns onto ATV and other parts. These have included such processes as applying a fabric to a plastic ATV body part and dual-color injection molding. These processes have tended to yield an unsatisfactory result, as they do not yield a part that has sufficient durability for the intended use. In addition, these results have been unsatisfactory due to an inability to create a repeatable result.

However, it is desirable to apply a pattern to ATV parts. In particular, it is desirable to apply a camouflage pattern of some sort onto the vehicle. This is so that the vehicle will be camouflaged if it is used for hunting purposes. In addition, many ATV drivers find a camouflage pattern to be attractive. Other designs, such as a marbled design, could be used on an ATV as well. However, the present application, and much of the research in this area, focuses on the application of a camouflage design to the ATV body.

A primary problem that arises in the present context occurs due to the selection of the material for forming the ATV parts. As set forth above, the bodies of ATVs are usually made from either polyethylene or polypropylene. Neither polyethylene nor polypropylene has strong adhesion properties for allowing a paint or pattern to be easily imprinted on or laminated thereto. However, this adhesion problem is particularly strong in the case of polyethylene, and in particular for HDPE. Accordingly, a solution that would be appropriate or acceptable for use with polypropylene parts will not necessarily work for parts made from HDPE. Accordingly, additional testing and experimentation has been necessary to develop an appropriate result.

One method used for polypropylene parts is a simple hydrographic process. In this process, a pattern is applied to a polypropylene part by dipping the part into a water bath that has an ink layer floating on top. Typically, the part is at least primed before it is dipped into the water bath with the pattern. Since the part is formed from polypropylene and is typically primed, there is no significant problem with regard to initial adhesion. The part, however, typically exhibits significant cold temperature brittleness and has adhesion difficulties over time.

A method utilizing hydrographic printing has also been used for HDPE parts. In this method, an HDPE part is pretreated to increase adhesion. More specifically, the HDPE part is subjected to a flame pretreatment step. After the pretreatment step, the part is then subjected to a hydrographic process. HDPE parts finished in accordance with the foregoing method, however, still have adhesion and cold impact deficiencies. Moreover, the adhesion difficulties also cause problems with weathering durability.

Many other pretreatment methods were tested to determine whether the use of any pretreatment method would increase the adhesion of the HDPE enough for the design to give a good appearance and a good cold impact result. The use of a primer, electrostatic and chemical treatments, as well as sandblasting, were tried. However, none of these pretreatments yielded a successful result.

Accordingly, a different method must be used for these parts in order to achieve an adequate level of adhesion and cold impact. One method that may be used is sublimation. In a sublimation process, ink is vaporized and then sprayed onto a part via a vacuum. The ink is sealed into the part through a heat treatment. While such a part does not suffer from the adhesion and cold impact problems mentioned above, the ink has a tendency to wear off or the design to otherwise fade due to weathering. In addition, the initial image has less clarity or sharpness. These difficulties are particularly apparent when the parts are made from HDPE.

Another method is adding a film to the surface of the part during the molding process. In such a process, the film is placed in the mold and then the HDPE is injected into the mold in accordance with known techniques. This method produces good results for adhesion and weathering. However, such a method is unavailable for complex shapes, due to the need to properly place the film in the mold. In addition, this method suffers from a tendency of the film to not be distributed evenly over the part.

The use of a co-injection process, whereby materials having multiple colors are co-injected into an injection mold was also examined. This process did not yield a part that was able to pass the cold impact requirements and was therefore abandoned.

Accordingly, what is needed is a method where a camouflage decoration can be economically applied to an ATV during mass production. The method must resolve the issues of adhesion to an HDPE part and the concerns regarding the impact durability. The present invention solves these and other problems that may be apparent to one of ordinary skill in the art.

### SUMMARY OF THE INVENTION

The present invention is directed to a method for decorating a vehicle body part that is comprised of a polyolefin. In accordance with the method, the vehicle body part is contacted with a gas mixture comprising fluorine. A design film is provided that includes a support sheet to which an ink design has been applied. The support sheet is composed of a material that is soluble in an aqueous liquid. The design film is placed in a tank containing an aqueous medium. After the vehicle body part has been contacted with the gas mixture, the vehicle body part is lowered into the tank, through the ink design, so as to be submerged in the aqueous medium, thereby causing the ink design to adhere to the vehicle body part. The vehicle body part is then removed from the tank. The method may also optionally include applying a base primer for proper color undertones. A clear coat, as is currently desirable for weather and abrasion resistance, may also be applied.

### BRIEF DESCRIPTION OF THE DRAWINGS

The features, aspects, and advantages of the present invention will become better understood with regard to the following description, appended claims, and accompanying drawings where:

FIG. 1 is a perspective view of an ATV;

FIG. 2 shows a body part of the ATV that is about to be dipped into a tank having a camouflage design film floating on an aqueous medium;

FIG. 3 shows the body part being sprayed with a clear coating after the body part was dipped into the tank and coated with the camouflage pattern.

### DETAILED DESCRIPTION OF THE PREFERRED EMBODIMENTS

It should be noted that in order to clearly and concisely disclose the present invention, the drawings may not necessarily be to scale and certain features of the invention may be shown in somewhat schematic form.

As set forth above, a problem that exists in the ATV manufacturing area is how to apply a camouflage design to an ATV body with good adhesion, without also damaging the ATV part, causing a reduced durability for cold impact. A variety of manufacturers have investigated a number of possible solutions. However, no solution found to date has been effective to overcome these problems.

The present inventors and others have done extensive research into an effective method for increasing the adhesion properties of an ATV part to allow the part to be decorated with a camouflage design. Until the time of the present invention, nobody has been able to develop a method that would create a part that has sufficient durability and adhesion simultaneously.

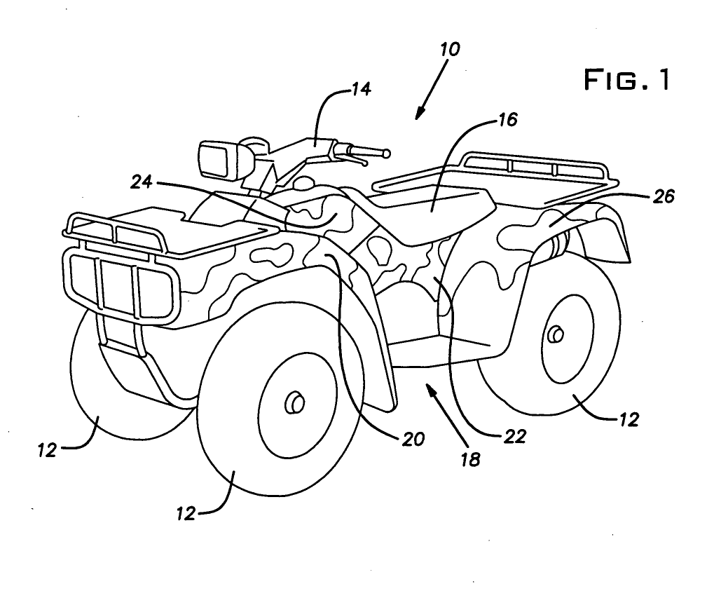

Referring now to FIG. 1 there is shown an ATV 10 having one or more body parts provided with a camouflage finish in accordance with the present invention. The ATV 10 includes a vehicle frame (not shown) with wheels 12 rotatably mounted thereto. At least a front pair of the wheels 12 is steerably connected to a handle 14 via a steering mechanism (not shown). A seat 16 is secured above the vehicle body frame and a power unit including an engine is mounted below the seat 16. The engine is drivably connected to the wheels 12 for rotating the same. A body 18 is secured to the vehicle frame and includes front fenders 20, side body panels 22, a center body panel 24 and rear fenders 26. One or more of the front fenders 20, side body panels 22, center body panel 24, rear fenders 26 and other body parts are provided with a camouflage finish in accordance with the present invention. In the description that follows, the body part(s) to be provided with a camouflage finish is/are referred to in the singular as the “ATV body part”.

The ATV body part is molded through any standard molding process to have a desired shape. Preferably, the ATV body part is molded through an injection molding process in a conventional manner.

The ATV body part is preferably made of a polyolefin. While the ATV body part may be made from any number of other materials, such as nylon and the like, the use of a polyolefin is preferred. More preferably, the ATV body part is comprised of high-density polyethylene (HDPE), due to its structural characteristics. A commercially available HDPE resin that has been found suitable for forming the ATV body part is Escorene HD-6706, which is sold by Exxon Chemical Canada. Polypropylene may alternatively be used, but is also less preferred.

After the ATV body part is formed, the surface of the ATV body part is treated with fluorine and preferably also oxygen to increase the surface energy level of the ATV body part, as measured in dynes. Before treatment, the ATV body part preferably has a dyne level of about 30 dynes/cm. The fluorine treatment (or fluorination) and the oxygen treatment (or oxidation) may be performed separately or together in an oxyfluorination stage. The fluorination and oxidation may be carried out by a method or methods wherein the ATV body part is contacted with a gas mixture or gas mixtures containing fluorine and oxygen, under conditions and for a period of time sufficient to render the surface of the ATV body part receptive to a hydrographic ink. If an oxyfluorination stage is utilized, a gas mixture containing fluorine and oxygen may be used, alone or together with other gases, such as gases inert in the process. Examples of such inert gases include nitrogen and helium. If separate fluorination and oxidation stages are utilized, the fluorination stage may utilize fluorine gas alone or a gas mixture including fluorine and a gas inert in the process, such as nitrogen, and the oxidation stage may simply utilize air, which, of course, contains oxygen. PCT patent application No. WO93/24559, which is hereby incorporated by reference, discloses a process wherein a film is partially fluorinated and then simply exposed to air. Another example of a fluorination method is disclosed in U.S. Pat. No. 4,296,151, which is also hereby incorporated by reference. A preferred fluorination method can be performed by the Fluoro-Seal Corporation of Houston, Tex. The most preferred fluorination method involves a high oxygen to fluorine gas mixture. This high oxygen mixture leaves an oxidized part surface with a high adhesion property.

The (oxy)fluorination treatment is performed for a period of time that is sufficient to raise the dyne level of the ATV part to a desired elevated level, which is preferably about 50 dynes/cm or greater. The amount of time the ATV part is subjected to the (oxy)fluorination treatment will be dependent on the untreated dyne level of the ATV part, on the type and amount of color pigments and anti-oxidants that are in the base plastic of the ATV part, and any oils or mold releases that may be on the surface of the base plastic of the ATV part.

Once the ATV body part has been treated with fluorine and preferably oxygen, a camouflage design is applied to the ATV body part through the process described below. Before the camouflage design is applied to the ATV body part, the ATV body part may be coated with a primer layer and/or a base paint layer using a spray gun or other type of paint applicator. The primer layer may be used to further promote adhesion, while the base paint layer may be used to set the base color of the ATV body part that affects the final appearance of the camouflage design. Preferably, however, the ATV body part is not coated with a primer layer or a base paint layer. The base color of the ATV body part is preferably set by using a pre-colored base plastic for forming the ATV body part.

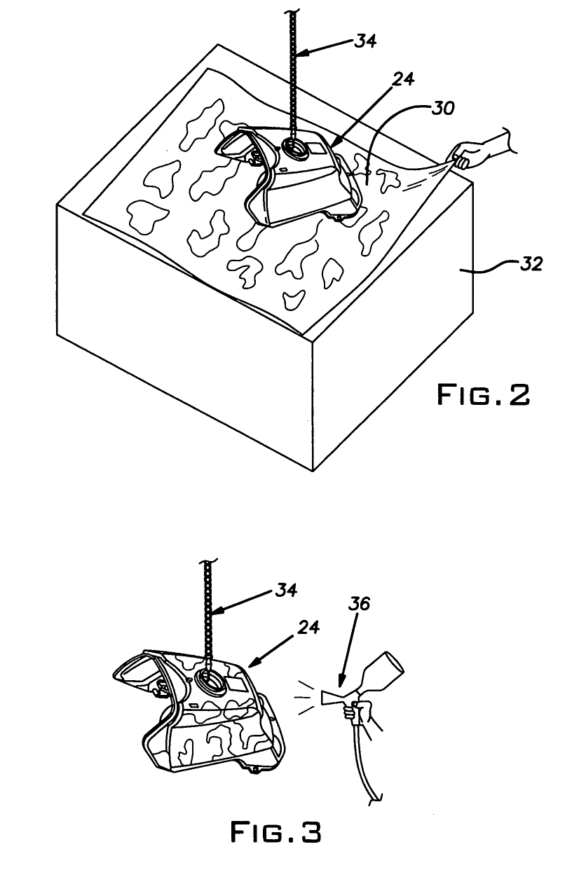

With reference now to FIG. 2, the camouflage design is applied to the ATV part (such as the center body panel 24) through a hydrographic process that utilizes a design film 30 with a camouflage design printed thereon. The design film 30 includes a support sheet upon which an ink design is applied. The ink design is formed from a plurality of multicolored inks and has a camouflage appearance. The support sheet is composed of a medium that is soluble in the aqueous medium to a degree necessary to permit the ink design to float on the surface of the aqueous medium. The support sheet used in the foregoing hydrographic process may be a starch film, a polyvinyl alcohol film, a polyvinyl alcohol-starch mixture film, or a coated or laminated film that comprises a liquid permeable base, such as paper, non-woven fabric and various porous films, coated or laminated with the above mentioned materials. Preferably, the support sheet is a polyvinyl alcohol (PVA) film.

The hydrographic inks used to form the ink design include a vehicle, a coloring agent, such as dyes or pigments and, optionally, conventional additives such as plasticizers, stabilizers, waxes, greases, dryers, auxiliary dryers, hardeners, thickeners, dispersing agents and fillers. Examples of ink vehicles include: oils and fats, such as linseed oil, soybean oil, and synthetic drying oils; natural or modified resins such as rosin, dammar, hardened rosin, rosin esters and polymer rosin; synthetic resins such as rosin-modified phenol resins, maleic acid resin, alkyd resins, petroleum resins, vinyl resins, acrylic resins, polyamide resins, epoxy resins, and aminoalkyd resins; cellulose derivatives such as nitrocellulose and ethyl cellulose; rubber derivatives such as rubber chloride and cyclized rubber and other materials such as glue, casein and dextrin.

The ink design on the support sheet may be produced using known procedures such as printing techniques, for example, gravure printing, lithographic printing, letter press and screen printing; coating techniques, for example, brushing, knife coating and spray coating, and picturing techniques, for example, hand painting and brush painting. By using the above mentioned techniques, it is possible to provide multi-color regions having a camouflage appearance.

The design film 30 with the camouflage design formed thereon is placed into a tank 32 filled with an aqueous medium. A solvent is then sprayed on the design film to help dissolve the design film (or more specifically the support sheet) and allow the ink design to float on top of the aqueous medium. The solvent is preferably an aromatic hydrocarbon, such as toluene, xylene, cyclohexane, or ethylbenzene. More preferably the solvent is xylene.

Using a lifting apparatus, such as a hoist 34 or a robot, the ATV body part (such as the center body panel 24) is dipped down into the tank 32 through the ink design so as to be submerged in the aqueous medium, which causes the ink design to adhere to the ATV body part as a result of the liquid pressure. The ATV body part is then raised and removed from the tank 32. The ATV body part is rinsed with water to remove any remaining portion of the support layer and then air dried. After the ATV body part has been air dried, the ATV body part is preferably coated with a clear coat (such as a urethane clear coat) using a spray gun 36 or other type of applicator, as is shown in FIG. 3.

Although the method of the present invention has been described with regard to an ATV body part, it should be appreciated that the method of the present invention may be used to impart a camouflage design to body parts for other vehicles, such as automobiles, motorcycles, trucks and sports utility vehicles, especially when the body parts are composed of polyolefins and the vehicles are for rugged off-road use. For example, it is envisioned that the method of the present invention may be used to provide fenders of dirt bikes with camouflage patterns.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

What is claimed is:

1. A method for decorating a vehicle body part that is comprised of a polyolefin, said method comprising the steps of:
(a.) contacting the vehicle body part with a gas mixture comprising fluorine;
(b.) providing a design film comprising a support sheet to which an ink design has been applied, said support sheet being comprised of a material that is soluble in an aqueous liquid;
(c.) placing the design film in a tank containing an aqueous medium;
(d.) after the vehicle body part has been contacted with the gas mixture, lowering the vehicle body part into the tank, through the ink design, so as to be submerged in the aqueous medium, thereby causing the ink design to adhere to the vehicle body part; and
(e.) removing the vehicle body part from the tank.

2. The method according to claim 1, wherein the vehicle body part is an ATV body part.

3. The method according to claim 2, wherein the vehicle body part is comprised of high-density polyethylene.

4. The method of claim 3, wherein the ink design is multicolored.

5. The method of claim 4, wherein the ink design is a camouflage design.

6. The method according to claim 5, further comprising the step:
(c2.) before the vehicle part is lowered into the tank, spraying a solvent onto the design film to help dissolve the design film such that the ink design floats on top of the aqueous medium in the tank.

7. The method according to claim 1, further comprising the step of:
(f.) coating the vehicle body part with a clear coat after the ink design has been adhered onto the vehicle body part.

8. The method according to claim 7, further comprising the step of:
(a2.) applying a primer coat to the vehicle body part after the vehicle body part has been contacted with the gas mixture and before the ink design has been adhered onto the vehicle body part.

9. The method according to claim 7, wherein the vehicle body part is composed of colored plastic.

10. The method according to claim 1, wherein the gas mixture further comprises oxygen.

11. The method according to claim 10, wherein the vehicle body part is contacted with the gas mixture for a period of time that is sufficient to raise the dyne level of the vehicle body part to greater than about 50 dynes/cm.

12. The method according to claim 1, wherein the support sheet comprises a polyvinyl alcohol (PVA) film.
